(19) United States
(12) Patent Application Publication
(10) Pub. No.: US 2026/0045010 A1
(43) Pub. Date: Feb. 12, 2026

(54) IMAGE EDITING WITH A SELECTED MACHINE-LEARNING MODEL

(71) Applicant: Google LLC, Mountain View, CA (US)

(72) Inventors: Alex Rav ACHA, Mountain View, CA (US); Yaron BRODSKY, Mountain View, CA (US); Qinghao CHU, Mountain View, CA (US); Shlomo FRUCHTER, Mountain View, CA (US); Yael Pritch KNAAN, Mountain View, CA (US); Matan COHEN, Mountain View, CA (US); Andrey VOYNOV, Mountain View, CA (US); Bryan FELDMAN, Mountain View, CA (US)

(73) Assignee: Google LLC, Mountain View, CA (US)

(21) Appl. No.: 19/296,673

(22) Filed: Aug. 11, 2025

Related U.S. Application Data
(60) Provisional application No. 63/682,231, filed on Aug. 12, 2024.

(51) Int. Cl. G06T 11/60; G06N 3/0985

(52) U.S. Cl. CPC G06T 11/60; G06N 3/0985; G06T 2200/24

(57) ABSTRACT

A computer-implemented method includes receiving an initial image and an original prompt from a user, wherein the original prompt includes a request to modify the initial image. The method further includes selecting, based on the original prompt, a machine-learning model from a set of machine-learning models. The method further includes providing the original prompt and the initial image as input to a large language model (LLM). The method further includes receiving, from the LLM and based on the original prompt and the initial image, a rewritten prompt. The method further includes selecting, based on the rewritten prompt, a machine-learning model from a set of machine-learning models. The method further includes generating, by the selected machine-learning model, an output image that satisfies the rewritten prompt.

### CROSS-REFERENCE TO RELATED APPLICATIONS

This application is a non-provisional application that claims priority under 35 U.S.C. § 119(e) to U.S. Provisional Patent Application No. 63/682,231, filed on Aug. 12, 2024 and entitled “Selection of Machine-Learning Model for Image Editing,” which is hereby incorporated by reference herein in its entirety.

### BACKGROUND

Generative artificial intelligence (AI) may be used to generate images from text prompts. Generative AI models have different strengths and weaknesses. For example, when a user provides a prompt requesting that an initial image of a user pointing to a pyramid be changed to a beach in Bali, some generative AI models generate an output image with an artifact of the pyramid because the shape of the pyramid does not correspond to the location of pixels in the output image where a beach is added.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method includes receiving an initial image and an original prompt from a user, wherein the original prompt includes a request to modify the initial image. The method further includes selecting, based on the original prompt, a machine-learning model from a set of machine-learning models. The method further includes providing the original prompt and the initial image as input to a large language model (LLM). The method further includes receiving, from the LLM and based on the original prompt and the initial image, a rewritten prompt. The method further includes providing the rewritten prompt and the initial image as input to the selected machine-learning model. The method further includes generating, by the selected machine-learning model, an output image that satisfies the rewritten prompt.

In some embodiments, the method further includes receiving user input that identifies one or more objects or a region in the initial image, wherein the rewritten prompt is further based on identification of the one or more objects or the region in the initial image that is to be modified. In some embodiments, the set of machine-learning models includes a structure-preserving machine-learning model, a shape-preserving machine-learning model, and a non-structure and non-shape preserving machine-learning model. In some embodiments, selecting the machine-learning model includes selecting the structure-preserving machine-learning model based on the rewritten prompt including a command to modify the one or more objects or the region in the initial image while preserving a structure of the one or more objects or the region. In some embodiments, providing the rewritten prompt and the initial image as input to the selected machine-learning model further includes providing the rewritten prompt, the initial image, and a depth map of the initial image to the structure-preserving machine-learning model. In some embodiments, selecting the machine-learning model includes selecting the shape-preserving machine-learning model based on the rewritten prompt including a command to modify the one or more objects or the region in the initial image while preserving a shape of the one or more objects or the region. In some embodiments, selecting the machine-learning model includes selecting the non-structure and non-shape preserving machine-learning model based on the rewritten prompt including a command to replace the one or more objects or the region in the initial image with one or more new objects or a new region. In some embodiments, responsive to selecting the non-structure and non-shape preserving machine-learning model, the method further includes: generating a minimum bounding box that surrounds one or more selected objects in the initial image, responsive to selecting the non-structure and non-shape preserving machine-learning model, generating a bounding-box mask based on the minimum bounding box, and providing, along with the rewritten prompt and the initial image, the bounding-box mask as input to the non-structure and non-shape preserving machine-learning model. In some embodiments, selecting the machine-learning model includes selecting the non-structure and non-shape preserving machine-learning model based on the rewritten prompt including a command to generate an additional object to be added to the initial image. In some embodiments, the method further includes generating a user interface that includes the initial image and an option to apply a preset to modify the initial image and responsive to receiving selection of the preset, outputting, by the machine-learning model, the output image that satisfies a command associated with the preset. In some embodiments, the preset includes at least one option selected from a group of removing a fence from the initial image, erasing an object in the initial image, adding a new object to the initial image, changing a material or color of an object in the initial image, enhancing the initial image, replacing a background of the initial image, changing a subject in the initial image (e.g., changing an expression of the subject, changing a feature of the subject, changing clothing of the subject, etc.), and combinations thereof.

A non-transitory computer-readable medium with instructions stored thereon that, when executed by one or more computers, cause the one or more computers to perform or control performance of the operations. The operations include receiving an initial image and an original prompt from a user, wherein the original prompt includes a request to modify the initial image; selecting, based on the original prompt, a machine-learning model from a set of machine-learning models; providing the original prompt and the initial image as input to an LLM; receiving, from the LLM and based on the original prompt and the initial image, a rewritten prompt; providing the rewritten prompt and the initial image as input to the selected machine-learning model; and generating, by the selected machine-learning model, an output image that satisfies the rewritten prompt.

In some embodiments, the operations further include receiving user input that identifies one or more objects or a region in the initial image, wherein the rewritten prompt is further based on identification of the one or more objects or the region in the initial image that is to be modified. In some embodiments, the set of machine-learning models includes a structure-preserving machine-learning model, a shape-preserving machine-learning model, and a non-structure and non-shape preserving machine-learning model. In some embodiments, the operations further include providing the output image with an option to regenerate the output image, receiving a subsequent prompt from the user, and generating a subsequent output image based on the subsequent prompt.

A system comprises one or more processors and one or more computer-readable media coupled to the one or more processors, having instructions stored thereon that, when executed by the one or more processors, cause the one or more processors to perform or control performance of operations. The operations include receiving an initial image and an original prompt from a user, wherein the original prompt includes a request to modify the initial image; selecting, based on the original prompt, a machine-learning model from a set of machine-learning models; providing the original prompt and the initial image as input to an LLM; receiving, from the LLM and based on the original prompt and the initial image, a rewritten prompt; providing the rewritten prompt and the initial image as input to the selected machine-learning model; and generating, by the selected machine-learning model, an output image that satisfies the rewritten prompt.

In some embodiments, the operations further include receiving user input that identifies one or more objects or a region in the initial image, wherein the rewritten prompt is further based on identification of the one or more objects or the region in the initial image that is to be modified. In some embodiments, the set of machine-learning models includes a structure-preserving machine-learning model, a shape-preserving machine-learning model, and a non-structure and non-shape preserving machine-learning model. In some embodiments, selecting the machine-learning model includes selecting the structure-preserving machine-learning model based on the rewritten prompt including a command to modify the one or more objects or the region in the initial image while preserving a structure of the one or more objects or the region. In some embodiments, selecting the machine-learning model includes selecting the shape-preserving machine-learning model based on the rewritten prompt including a command to modify the one or more objects or the region in the initial image while preserving a shape of the one or more objects or the region.

### BRIEF DESCRIPTION OF THE DRAWINGS

FIG. 1 is a block diagram illustrating an example network environment, according to some embodiments described herein.

FIG. 2 is a block diagram illustrating an example computing device, according to some embodiments described herein.

FIG. 3A illustrates an example user interface with an initial image that includes a fence and a preset for removing the fence, according to some embodiments described herein.

FIG. 3B illustrates an example user interface with an output image without the fence, according to some embodiments described herein.

FIGS. 4A-4B illustrate an example user interface with an automatic suggestion to modify a region of an initial image and an example user interface with an output image that results from selecting the automatic suggestion, according to some embodiments described herein.

FIGS. 5A-5C illustrate example user interfaces that include an initial image, receive an original prompt from a user, and display an output image responsive to a rewritten prompt, respectively, according to some embodiments described herein.

FIGS. 6A-6C illustrate an example initial image of a cat, an example initial image that includes a bounding box, and an example output image, according to some embodiments described herein.

FIGS. 7A-7C illustrate other example user interfaces that include an initial image, receive an original prompt from a user, and display an output image responsive to a rewritten prompt, respectively, according to some embodiments described herein.

FIGS. 8A-8C illustrate other example user interfaces that include an initial image, receive an original prompt from a user, and display an output image responsive to a rewritten prompt, respectively, according to some embodiments described herein.

FIG. 9A-9C illustrate architectures an example machine-learning models, according to some embodiments described herein.

FIG. 10 illustrates a flowchart of a method to generate an output image based on a rewritten prompt and an initial image, according to some embodiments described herein.

### DETAILED DESCRIPTION

### Overview

With the proliferation of digital cameras and smartphones, users can easily capture, store, and share vast numbers of digital images. As image editing software becomes more accessible and sophisticated, users increasingly want to modify their images in creative and complex ways. Traditional image editing tools often require significant technical skill and manual effort to achieve desired results, such as changing an object's color, altering its texture, or replacing it entirely.

Recent advancements in generative artificial intelligence (AI), particularly in the field of image generation, have introduced new possibilities for image manipulation. A generative AI model can generate or modify images based on textual prompts. The generative AI model can receive text requests from users that describe a desired change in natural language, and the generative AI model attempts to produce a corresponding visual output. For example, a user can provide an image of a cat and a prompt like “make the cat orange,” and the system will generate a new image with an orange cat.

However, existing generative AI models for image editing face several challenges. One significant issue is the ambiguity of user prompts. A user might provide a short, context-lacking prompt, such as “make it shiny” or “wavy.” Without understanding the context of the image and the user's intent, the generative AI model may misinterpret the request, leading to unintended or nonsensical results. For example, when editing an image of a car, the prompt “brand new” could be misapplied by the generative AI model and result in the generative AI model generating something other than a brand-new car. In addition, using these traditional generative AI models is computationally expensive because a user may have to request multiple iterations of image generation until they are satisfied with the results.

Another challenge lies in controlling the degree and nature of the modification. Sometimes a user may wish to preserve the underlying structure and shape of an object while changing its appearance (e.g., changing the material of a car in an initial image from metal to wood). In other cases, the user might want to preserve the general shape of a region but alter its internal structure (e.g., making a calm lake in an initial image look wavy). In yet other scenarios, the user may want to completely replace an object with a new one, disregarding both an original shape and structure (e.g., replacing a cat with a dog). A single generative AI model that is trained to output a particular type of image is often ill-equipped to handle this wide range of user intentions effectively, as a model optimized for structure preservation may struggle with object replacement, and vice versa. There is a need for a way to select from multiple generative AI model based on user intent to produce high-quality, relevant results.

The technology described herein advantageously addresses these and other issues by using a large language model (LLM) to rewrite prompts and by using different machine-learning models based on the rewritten prompt. For example, the technology includes receiving an initial image and an original prompt where the original prompt includes a request to modify the initial image. The original prompt defines one or more image modification tasks to be executed with regard to the initial image. The original prompt may include limited information, such as “reimagine to gold.” User input may also be provided, such as selection of an object (e.g., where a user taps different objects in an initial image until the object that the user wants to modify is highlighted, circling an object, etc.).

The initial image and the original prompt (and optionally user input) are provided to an LLM or other text-generation model. In some embodiments, the LLM or other text generation model may be a multimodal model that can process as input—text, image, video, gesture input, or other types of input. The LLM rewrites the prompt. A rewritten prompt corresponds to the respective original prompt, i.e. specifies the same one or more (image modification) tasks for modifying the initial image, but the rewritten prompt further meets at least one of the following criteria: it is more clear instruction to the machine-learning model, it is a more concise instruction to the machine-learning model, and/or its wording/instruction(s) improves the performance of the machine-learning model. The LLM is trained to rewrite the prompt such that at least one of the above-mentioned criteria is met by the rewritten prompt, i.e. the LLM rewrites the prompt such that at least one of the above-mentioned criteria is met by the rewritten prompt. For example, continuing with the example above, an original prompt of “reimagine gold” may be rewritten as “reimagine to a golden statue of an eagle's head” where the initial image is an eagle. If the user input is not provided and/or a user did not select an object in the initial image, the LLM may generate a rewritten prompt that associates the original prompt with the only object in the image or a most prominent object in the image (e.g., identifying an object that is in the foreground when other objects are in the background).

A machine-learning model is selected from a set of machine-learning models to be used for generating an output image. In some embodiments, the machine-learning model is selected by a media application based on the original prompt. For example, if the user input circles a cat and the original prompt is “make pink,” the media application selects a shape-preserving machine-learning model. In some embodiments, the machine-learning model is selected by the LLM. For example, continuing with the same example, the rewritten prompt may be “make the selected region pink, preserving the shape and texture.” As a result, the shape-preserving machine-learning model is selected.

Different generative models may have different capabilities and/or limitations (e.g., recoloring an image, adding/removing objects, artistic effects, known failure modes, preserving image structure and/or object shapes, etc.). For example, if the rewritten prompt requests a change to the color of the object, a structure-preserving machine-learning model is selected. If the rewritten prompt requests that water underneath a bridge be changed to icy water under the bridge, a shape-preserving machine-learning model is selected. If the rewritten prompt requests that an object be replaced with a different object, a non-structure and non-shape preserving machine-learning model is selected.

### Network Environment

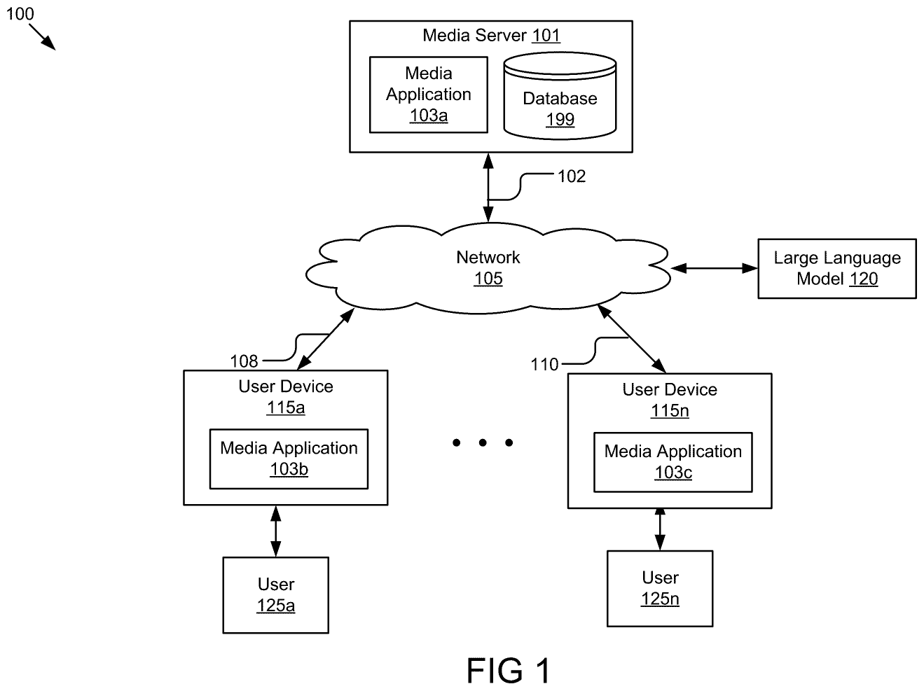

FIG. 1 illustrates a block diagram of an example environment 100. In some embodiments, the environment 100 includes a media server 101, a user device 115a, a user device 115n, and a large language model (LLM) 120 that are each coupled to a network 105. Users 125a, 125n may be associated with respective user devices 115a, 115n. In some embodiments, the environment 100 may include other servers or devices not shown in FIG. 1. In FIG. 1 and the remaining figures, a letter after a reference number (e.g., “115a”) represents a reference to the element having that particular reference number. A reference number in the text without a following letter (e.g., “115”) represents a general reference to embodiments of the element bearing that reference number.

The media server 101 may include a processor, a memory, and network communication hardware. In some embodiments, the media server 101 is a hardware server. The media server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some embodiments, the media server 101 sends and receives data to and from one or more of the user devices 115a, 115n via the network 105. The media server 101 may include a media application 103a and a database 199.

The database 199 may store machine-learning models, training data sets, images, etc. The database 199 may also store social network data associated with users 125, user preferences for the users 125, etc.

The user device 115 may be a computing device that includes a memory coupled to a hardware processor. For example, the user device 115 may include a mobile device, a tablet computer, a mobile telephone, a wearable device, a head-mounted display, a mobile email device, a portable game player, a portable music player, a reader device, or another electronic device capable of accessing a network 105.

In the illustrated embodiment, user device 115a is coupled to the network 105 via signal line 108 and user device 115n is coupled to the network 105 via signal line 110. The media application 103 may be stored as media application 103b on the user device 115a and/or media application 103c on the user device 115n. Signal lines 108 and 110 may be wired connections, such as Ethernet, coaxial cable, fiber-optic cable, etc., or wireless connections, such as Wi-Fi®, Bluetooth®, or other wireless technology. User devices 115a, 115n are accessed by users 125a, 125n, respectively. The user devices 115a, 115n in FIG. 1 are used by way of example. While FIG. 1 illustrates two user devices, 115a and 115n, the disclosure applies to a system architecture having one or more user devices 115.

The media application 103 may be stored on the media server 101 and/or the user device 115. In some embodiments, the operations described herein are performed on the media server 101 or the user device 115. For example, a media application 103b on the user device 115a may receive an initial image captured by the user device 115a and generate an output image. In some embodiments, some operations may be performed on the media server 101 and some may be performed on the user device 115. For example, an initial image may be captured by the user device 115a and transmitted with user input and a prompt to the media application 103a on the media server 101, which generates an output image that is transmitted to the media application 103b on the user device 115a for display.

Performance of operations is in accordance with user settings. For example, the user 125a may specify settings that operations are to be performed on their respective user device 115a and not on the media server 101. With such settings, operations described herein are performed entirely on user device 115a and no operations are performed on the media server 101. Further, a user 125a may specify that images and/or other data of the user is to be stored only locally on a user device 115a and not on the media server 101. With such settings, no user data is transmitted to or stored on the media server 101. Transmission of user data to the media server 101, any temporary or permanent storage of such data by the media server 101, and performance of operations on such data by the media server 101 are performed only if the user has agreed to transmission, storage, and performance of operations by the media server 101. Users are provided with options to change the settings at any time, e.g., such that they can enable or disable the use of the media server 101.

Machine-learning models (e.g., diffusion models or other types of models), if utilized for one or more operations, are stored and utilized locally on a user device 115, with specific user permission. Server-side models are used only if permitted by the user. Further, a trained model may be provided for use on a user device 115. During such use, if permitted by the user 125, on-device training of the model may be performed. Updated model parameters may be transmitted to the media server 101 if permitted by the user 125, e.g., to enable federated learning. Model parameters do not include any user data.

The media application 103 receives an initial image and an original prompt from a user. The original prompt includes a request to modify the initial image. In some embodiments, the media application 103 also receives user input that identifies one or more objects or a region in the initial image. For example, a user may circle an object in the initial image and provide a textual request to change a color of the object to a different color, change features of a region to different features, or replace an original object with a new object.

The media application 103 provides the original prompt as input to an LLM 120. The LLM is trained/arranged to rewrite (e.g., optimize) prompts such that a machine-learning model that will be selected for executing the prompt can execute the prompt correctly and in a more accurate way, i.e. such that the prompt is understandable not only by a human but is an optimized input for the machine-learning model that will execute the prompt. The LLM may implement the prompt rewriting by different methods such as supervised learning with reinforcement learning, reinforcement learning-based prompt rewriting, instruction and example-based prompt rewriting, meta-prompting and few-shot demonstrations, automated multi-turn iterative rewriting, or any other appropriate method, wherein also any combination of the methods is possible for implementing the prompt rewriting. The rewriting of prompts improves the effectiveness and quality of the machine-learning model's responses. Although FIG. 1 is illustrated as including an LLM 120, other text-generation models may be used. The LLM 120 is illustrated in FIG. 1 as being separate from the media application 103; however, in some embodiments, the LLM 120 is part of the media application 103. The media application 103 receives from the LLM 120, based on the original prompt and the initial image, a rewritten prompt. In some embodiments, the rewritten prompt is also based on user input, such as an identification of an object or a region in the initial image.

The media application 103 selects a machine-learning model from a set of machine-learning models. For example, the media application 103 may select a structure-preserving machine-learning model for a rewritten prompt that requests changing a color of an object, select a shape preserving machine-learning model for a rewritten prompt requesting to change an ocean from appearing calm to a wavy ocean, or select a non-structure and non-shape preserving machine-learning model for a rewritten prompt to replace an original object with a new object or add an additional object to the initial image. The selected machine-learning model generates an output image in response to the rewritten prompt.

In some embodiments, the media application 103 may be implemented using hardware including a central processing unit (CPU), a field-programmable gate array (FPGA), an application-specific integrated circuit (ASIC), machine learning processor/co-processor, any other type of processor, or a combination thereof. In some embodiments, the media application 103a may be implemented using a combination of hardware and software.

### Computing Device

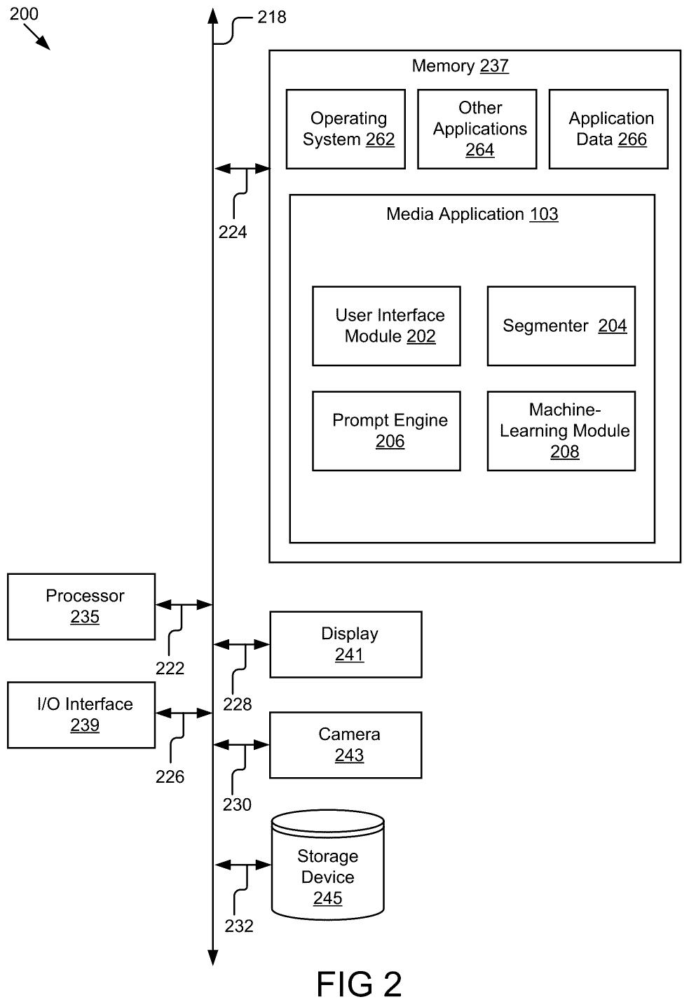

FIG. 2 is a block diagram of an example computing device 200 that may be used to implement one or more features described herein. Computing device 200 can be any suitable computer system, server, or other electronic or hardware device. In one example, computing device 200 is media server 101 used to implement the media application 103a. In another example, computing device 200 is a user device 115.

In some embodiments, computing device 200 includes a processor 235, a memory 237, an input/output (I/O) interface 239, a display 241, a camera 243, and a storage device 245 all coupled via a bus 218. The processor 235 may be coupled to the bus 218 via signal line 222, the memory 237 may be coupled to the bus 218 via signal line 224, the I/O interface 239 may be coupled to the bus 218 via signal line 226, the display 241 may be coupled to the bus 218 via signal line 228, the camera 243 may be coupled to the bus 218 via signal line 230, and the storage device 245 may be coupled to the bus 218 via signal line 232.

Processor 235 can be one or more processors and/or processing circuits to execute program code and control basic operations of the computing device 200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some embodiments, processor 235 may include one or more co-processors that implement neural-network processing. In some embodiments, processor 235 may be a processor that processes data to produce probabilistic output (e.g., the output produced by processor 235 may be imprecise or may be accurate within a range from an expected output). Processing need not be limited to a particular geographic location or have temporal limitations. For example, a processor may perform its functions in real-time, offline, in a batch mode, etc. Portions of processing may be performed at different times and at different locations, by different (or the same) processing systems. A computer may be any processor in communication with a memory.

Memory 237 is typically provided in computing device 200 for access by the processor 235, and may be any suitable processor-readable storage medium, such as random access memory (RAM), read-only memory (ROM), Electrical Erasable Read-Only Memory (EEPROM), Flash memory, etc., suitable for storing instructions for execution by the processor or sets of processors, and located separate from processor 235 and/or integrated therewith. Memory 237 can store software operating on the computing device 200 by the processor 235, including a media application 103.

The memory 237 may include an operating system 262, other applications 264, and application data 266. Other applications 264 can include, e.g., an image library application, an image management application, an image gallery application, communication applications, web hosting engines or applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

The application data 266 may be data generated by the other applications 264 or hardware of the computing device 200. For example, the application data 266 may include images used by the image library application and user actions identified by the other applications 264 (e.g., a social networking application, etc.).

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 245), and input/output devices can communicate via I/O interface 239. In some embodiments, the I/O interface 239 can connect to interface devices such as input devices (keyboard, pointing device, touchscreen, microphone, scanner, sensors, etc.) and/or output devices (display devices, speaker devices, printers, monitors, etc.).

Some examples of interfaced devices that can connect to I/O interface 239 can include a display 241 that can be used to display content, e.g., images, video, and/or a user interface of an output application as described herein, and to receive touch (or gesture) input from a user. For example, display 241 may be utilized to display a user interface that includes a graphical guide on a viewfinder. Display 241 can include any suitable display device such as a liquid crystal display (LCD), light emitting diode (LED), or plasma display screen, cathode ray tube (CRT), television, monitor, touchscreen, three-dimensional display screen, or other visual display device. For example, display 241 can be a flat display screen provided on a mobile device, multiple display screens embedded in a glasses form factor or headset device, or a monitor screen for a computer device.

Camera 243 may be any type of image capture device that can capture images and/or video. In some embodiments, the camera 243 captures images or video that the I/O interface 239 transmits to the media application 103.

The storage device 245 stores data related to the media application 103. For example, the storage device 245 may store a training data set that includes labeled images, a machine-learning model, output from the machine-learning model, etc.

FIG. 2 illustrates an example media application 103, stored in memory 237, that includes a user interface module 202, a segmenter 204, a prompt engine 206, and a machine-learning module 208. The user interface module 202, segmenter 204, prompt engine 206, and machine-learning module 208 may be implemented as code or other computer-readable instructions that are executable by one or more processors, such as the processor 235.

The user interface module 202 generates graphical data for displaying a user interface that includes images. The user interface module 202 receives initial images. The initial images may be received from the camera 243 of the computing device 200 or from the media server 101 via the I/O interface 239.

Before the initial image is processed, the user interface provides a user with a request for user consent to modify the image. In some embodiments, such consent may be obtained once by the media application 103 for all future images. The user is provided with options to revoke such one-time consent and to require consent for each image. The user interface module 202 does not collect or make use of user information unless the user provides user consent.

The initial image includes one or more objects. In some embodiments, the initial image also includes one or more human subjects (e.g., one or more objects in the initial image may correspond to a human subject, e.g., a human face, a human body, etc.). In some embodiments, the user interface module 202 receives user input that selects the one or more objects in the initial image. The user input may include surrounding the one or more objects in the initial image (e.g., by drawing a circle or other shape around an object that at least approximately encloses object), moving a finger over the one or more objects, tapping on the one or more objects in the initial image, providing a textual identification of the one or more images, etc.

The user interface may highlight the one or more objects in response to receiving the user input. In some embodiments, where a tap may be associated with multiple objects, a different number of taps may cause the user interface to highlight different objects. For example, where the initial image is a beach scene and a pail is in front of a sandcastle, tapping on the pail/sandcastle area a first time causes the pail to be highlighted first, tapping on the pail/sandcastle area a second time causes the sandcastle to be highlighted, and tapping on the pail/sandcastle area a third time causes both the pail and the sandcastle to be highlighted.

The user interface includes an option for providing a textual request associated with the one or more selected objects in the initial image. For example, the user interface may include a text field where the user directly inputs the textual request (also known as an original prompt), a text field with a preset, a microphone button for providing audio input that is converted to a textual request, etc.

In some embodiments, the user interface module 202 generates presets that are displayed with an initial image. The user interface module 202 generates a preset as a selectable icon that, when selected, causes an output image to be generated that satisfies the description in the preset. In some embodiments, the user interface module 202 provides the same set of presets in response to a user selecting an edit button and/or a suggestions button. In some embodiments, the set of presets are customized based parameters such as the type of objects and regions in the initial image. The user interface module 202 may receive segmentation information from the segmenter 204 that divides the initial image into different sections. The user interface module 202 may generate different presets based on the segmentation. In some embodiments, the user interface module 202 performs object recognition to identify types of objects in the different segments of the initial image. For example, the initial image may be divided into a background and have presets related to a background (e.g., change sky to different types of sky, change buildings to different types of buildings, change water bodies to different types of water bodies, etc.), one or more objects, etc.

In some embodiments, the presets include selectable buttons or links for erasing an object in an initial image, adding a new object to an initial image, changing a material or color of an object in an initial image, enhancing an initial image (e.g., by correcting a tone of the initial image, unblurring an object in the initial image, removing a reflection in the initial image, etc.), replacing a background of an initial image, changing a subject in an initial image (e.g., changing an expression of the subject, changing a feature of the subject, changing clothing of the subject, etc.), and removing a fence in an initial image.

The user interface module 202 generates graphical data for displaying an output image. In some embodiments, the user interface module 202 includes options for enabling multiple edits to an initial image. For example, a user may provide a first original prompt and receive a first output image, the user may provide a second original prompt and receive a second output image, etc. until the user is satisfied with the results. The user interface may also include options for sharing the output image, adding the output image to a photo album, adding a title to the output image, etc.

In some embodiments, the user interface module 202 generates a textual response based on the original prompt and the rewritten prompt that is displayed along with the output image. For example, if the user provided an original prompt that states “make it silver,” and the rewritten prompt is “make the tree silver by using a structure-preserving machine-learning model,” the textual response that is displayed along with the output image is “we have changed the color of the tree to silver.”

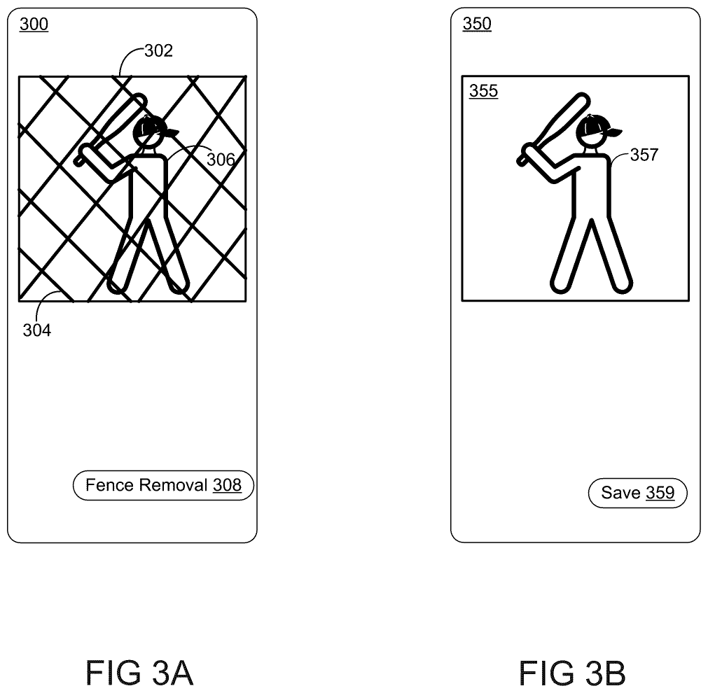

FIG. 3A illustrates an example user interface 300 with an initial image 302 that includes a fence 304 in front of a subject 306 and a preset 308 for removing the fence, according to some embodiments described herein. The user interface module 202 performs object recognition on the initial image 302 and identifies that the initial image 302 includes the fence 304 and the subject 306. The user interface module 202 generates a “fence removal” preset 308 that, when selected, commands the machine-learning model to generate an output image without the fence 304. In some embodiments, in response to a user selecting the “fence removal” preset 308, the prompt engine 206 (in some embodiments via an LLM) generates a rewritten prompt with instructions to use a non-structure and non-shape preserving machine-learning model to remove the fence 304.

FIG. 3B illustrates an example user interface 350 with an output image 355 that includes the subject 357 (corresponding to the subject 306 of FIG. 3A) without the fence 304 of FIG. 3A, according to some embodiments described herein. The user interface module 202 receives the output from the machine-learning module 208 (e.g., from the non-structure and non-shape preserving machine-learning model) and displays the output image 355. The user may continue editing the output image 355 or may select the “save” button 359 to save the output image.

In some embodiments, the user interface module 202 generates an automatic suggestion. An automatic suggestion differs from a present in that the automatic suggestion includes a suggestion that may be modified. In some embodiments, the user interface module 202 generates an automatic suggestion based on objects and/or regions in an initial image, based on most commonly suggested requests (either based on a particular user or based on all users), etc.

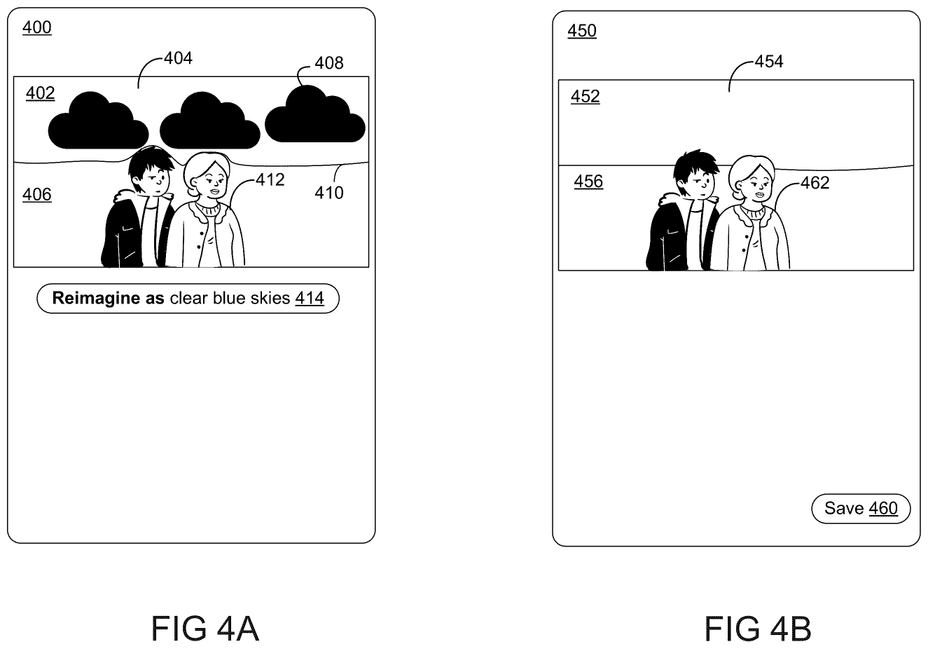

FIGS. 4A-4B illustrate an example user interface 400 with an automatic suggestion to modify a region of an initial image 402 and an example user interface 450 with an output image 452 that results from selecting the automatic suggestion, according to some embodiments described herein.

The user interface module 202 receives segmentation information from the segmenter 204 and divides the initial image 402 into a background region 404 and a foreground region 406. The background region 404 includes clouds 408 and is demarcated with a line 410 to show the area that is affected by changes. The foreground region 406 includes subjects 412.

The user interface module 202 generates a suggestion 414 to “Reimagine as clear blue skies” where “clear blue skies” is determined by the user interface module 202 based on identifying the background region 404 as including a sky with clouds 408. The suggestion 414 is editable such that a user may change it from, for example “clear blue skies” to “sunset,” “dark and stormy,” etc.

Responsive to a user selecting the suggestion 414 in FIG. 4A, the user interface module 202 generates graphical data for displaying the output image 452 in FIG. 4B. The output image 452 has a foreground region 456 and a background region 454. The background region 454 has clear blue skies and the clouds 408 from FIG. 4A are not part of the output image 452. The foreground region 456 includes the same subjects 462.

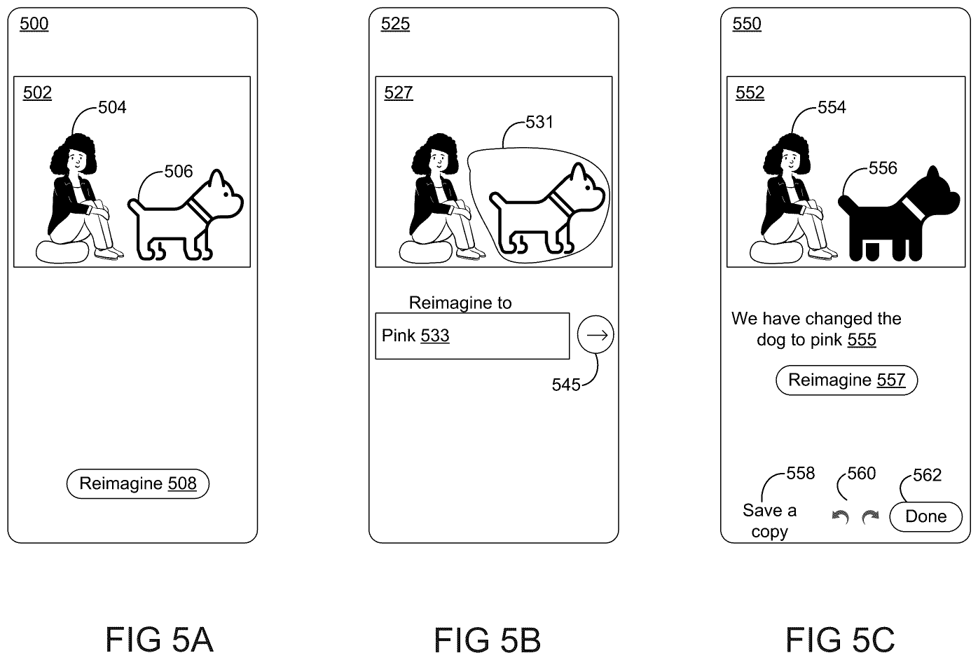

FIG. 5A illustrates an example user interface 500 that includes an initial image 502, according to some embodiments described herein. The initial image 502 includes a human subject 504 and a white dog 506. The user interface 500 also includes a reimagine button 508. Selecting the reimagine button 508 causes the user interface module 202 to generate the user interface 525 illustrated in FIG. 5B.

FIG. 5B illustrates an example user interface 525 that receives user input 531 on the initial image 527 and a text field for receiving an original prompt 533 from a user, according to some embodiments described herein. The user provides the user input 531 by circling the dog and adding “Pink” to the text field to create an original prompt 533. By circling the dog and adding “Pink” to the text field 533, the user is indicating that the user wants to change the dog to a pink dog. The user selects the arrow button 545 to generate the output image.

As is described in greater detail below, the prompt engine 206 receives the original prompt provided by the user and the initial image. In embodiments where the user provided user input, the prompt engine 206 also receives the user input. In some embodiments, the prompt engine 206 specifies a selected machine-learning model. The LLM generates a rewritten prompt based on the initial image, the original prompt, and user input if available. Continuing with the examples in FIGS. 5A and 5B, the prompt engine 206 rewrites the original prompt to combine the user input 531 selecting the dog with the original prompt 533 to form the rewritten prompt “A pink dog.” In some embodiments, the rewritten prompt also specifies a selected machine-learning model. For example, the rewritten prompt may include “a pink dog generated by a structure-preserving machine-learning model.” In some embodiments, the rewritten prompt is not visible to the user. In some embodiments, the rewritten prompt is visible to the user to act as a guide in how to draft future requests.

In embodiments where a user's face is used as part of an original prompt and/or a rewritten prompt, the user is provided with guidance regarding the use of user information, how the user information may be used to generate images (e.g., that include generated images that include the face), and how the user information is stored, etc. If the user chooses to accept the applicable terms and conditions, and provides permission, the process of generating the output image is started. The user can choose to not use user features, in which case no images are captured. User information is part of creation only in certain states/countries, where the creation, storage, and use of a user information is permitted, and in accordance with applicable regulations. In some embodiments, the image of the user is uploaded for use in creating an output image. Once the output image is generated, the machine-learning module 208 deletes the captured images of the user. In some embodiments, identifying information associated with the user is removed from the output image. The output image is stored locally on the user device and is used specifically with user permission and in compliance with applicable regulations.

FIG. 5C illustrates an example user interface 550 that displays an output image 552 that satisfies a rewritten prompt, according to some embodiments described herein. The output image 552 includes the person 554 and a pink dog 556. In this example, the user interface 550 also includes the statement 555 “we have changed the dog to pink” and a reimagine button 557 so that the user can further modify the output image if the user is not satisfied with the result. The user may save a copy of the output image by selecting the “Save a copy” link 558, undo the changes by selecting the undo button 560, or select the done button 562.

The segmenter 204 segments initial images. In some embodiments where a user selects one or more objects or a region, the segmenter 204 generates a user-selected mask. In some embodiments, the segmenter 204 generates a segmentation mask that identifies object pixels or region pixels associated with the one or more objects or a region based on segmenting the one or more objects or the region.

The segmenter 204 may segment the one or more objects in the initial image automatically or in response to user input. For example, the segmenter 204 may automatically segment different objects and/or regions in an initial image to create a segmentation mask. In another example, the user interface receives user input identifying an object to be modified, removed, and/or replaced and the segmenter 204 segments the object in response to the object being selected to create a user-selected mask. Segmentation refers to determining pixels of the image that belong to a particular object. In some embodiments, the segmenter 204 generates a segmentation map that associates an identity with each pixel in the initial image as belonging to particular objects or portions thereof (e.g., the face, the body, an object, etc.).

The segmenter 204 may perform the segmentation by detecting objects in an initial image. The object may be a person, an animal, a car, a building, etc. A person may be a subject of the initial image or is not the subject of the initial image (e.g., a bystander captured in the initial image). A bystander may include people walking, running, riding a bicycle, standing behind the subject, or otherwise within the initial image. In different examples, a bystander may be in the foreground (e.g., a person crossing in front of the camera), at the same depth as the subject (e.g., a person standing to the side of the subject), or in the background. In some examples, there may be more than one bystander in the initial image. The bystander may be a human in an arbitrary pose (e.g., standing, sitting, crouching, lying down, jumping, etc.). The bystander may face the camera, may be at an angle to the camera, or may face away from the camera.

The segmenter 204 may detect types of objects by performing object recognition, comparing the objects to object priors of people, vehicles, buildings, etc. to identify expected shapes of objects to determine whether pixels are associated with a selected object or a background.

In some embodiments, the segmenter 204 generates a segmentation mask or a user-selected mask based on the segmentation that indicates the pixels that are to be modified. The segmentation mask or the user-selected mask is used by a machine-learning model to determine the pixels in an initial image that are to be modified based on a rewritten prompt. In some embodiments, the segmentation mask or a user-selected mask corresponds to the segmentation such that the mask identifies a selected object or a selected region. In some embodiments where the original prompt provided by the user includes a request to replace the object, the segmenter 204 generates a segmentation mask that corresponds to a bounding box with x, y coordinates and a scale. The bounding box may be a minimum bounding box that is defined as a smallest rectangle that captures all the pixels associated with the object.

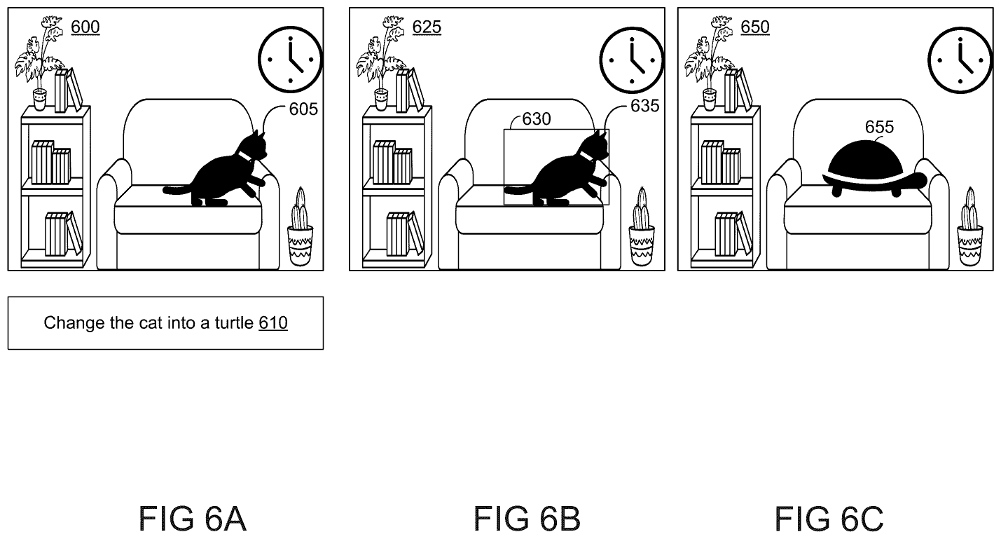

FIG. 6A illustrates an example initial image 600 of a cat 605 according to some embodiments described herein. A user provides the following prompt in a text field 610 “Change the cat into a turtle.” The segmenter 204 generates a minimum bounding box corresponding to the cat and generates a segmentation mask from the minimum bounding box. The segmenter 204 generates a bounding-box mask from the minimum bounding box that indicates a region where a first object in an initial image is to be replaced by a second object in an output image. The second object is not limited to the structure and/or the shape of the first object.

FIG. 6B is an example initial image 625 of the cat 630 and a minimum bounding box 635 that includes the cat 630. The minimum bounding box 635 includes all pixels associated with the cat 630 that result in forming a box. Using a bounding box to delineate the pixels that are associated with a replacement object in an output image advantageously identifies an area for the replacement object without limiting the replacement object to characteristics associated with an original object. For example, if the machine-learning model received a segmentation mask that corresponded to the pixels for the cat in FIG. 6A, the turtle may have attributes of a cat (e.g., a shape, texture, etc.). Instead, FIG. 6C illustrates an example output image 650 of a turtle 655 that has the attributes of a turtle and not a cat, according to some embodiments described herein. The user may save a copy of the output image (not shown), undo the changes (not shown), or select a done button (not shown).

In some embodiments, the segmenter 204 generates a depth map for the initial image. A depth map is a representation of the distance or depth information for each pixel in the initial image. The depth map may be a two-dimensional array where each pixel contains a value that represents the distance from the camera (e.g., camera 243 if the computing device 200 captured the initial image) to a corresponding point in the scene. The depth map provides a continuous representation of the depth information of the scene captured in the initial image. The depth map may be generated using a depth sensor (if available in the initial image as metadata generated during image capture or by deriving depth from pixel values using depth-estimation techniques).

The segmenter 204 may generate a user-selected mask or a segmentation mask based on generating superpixels for the image and matching superpixel centroids to depth map values to cluster detections based on depth. More specifically, depth values in a masked area may be used to determine a depth range and superpixels may be identified that fall within the depth range. Another technique for generating the user-selected mask or the segmentation mask includes weighing depth values based on how close the depth values are to the user-selected mask or the segmentation mask where weights were represented by a distance transform map.

In some embodiments, the segmenter 204 generates a preserving mask that identifies pixels that are to be preserved in the initial image. In some embodiments, the preserving mask is generated for pixels corresponding to a part of a subject, such as face, hands, the whole body, etc.

In some embodiments, the segmenter 204 may specify a circuit configuration (e.g., for a programmable processor, for a field programmable gate array (FPGA), etc.) enabling processor 235 to apply a machine-learning model. In some embodiments, the segmenter 204 may include software instructions, hardware instructions, or a combination. In some embodiments, the segmenter 204 may offer an application programming interface (API) that can be used by the operating system 262 and/or other applications 264 to invoke the segmenter 204 (e.g., to apply the machine-learning model to application data 266 to output the mask).

The segmenter 204 uses training data to generate a trained machine-learning model. For example, training data for generating segmentation masks may include pairs of initial images with one or more objects or a region and output images with one or more segmentation masks. Training data for generating user-selected masks may include pairs of initial images with user-selected objects or regions and output images with one or more user-selected masks. Training data for generating preserving masks may include pairs of initial images with one or more subjects and output images with one or more preserving masks.

Training data may be obtained from any source (e.g., a data repository specifically marked for training, data for which permission is provided for use as training data for machine learning, etc.). In some embodiments, the training may occur on the media server 101 that provides the training data directly to the user device 115, the training occurs locally on the user device 115, or a combination of both.

In some embodiments, the segmenter 204 uses weights that are taken from another application and are unedited/transferred. For example, in these embodiments, the trained model may be generated (e.g., on a different device) and be provided as part of the segmenter 204. In various embodiments, the trained model may be provided as a data file that includes a model structure or form (e.g., that defines a number and type of neural network nodes, connectivity between nodes and organization of the nodes into a plurality of layers), and associated weights. The segmenter 204 may read the data file for the trained model and implement neural networks with node connectivity, layers, and weights based on the model structure or form specified in the trained model.

The trained machine-learning model may include one or more model forms or structures. For example, model forms or structures can include any type of neural-network, such as a linear network, a deep-learning neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that receives as input sequential data, such as words in a sentence, frames in a video, etc. and produces as output a result sequence), etc.

The model form or structure may specify connectivity between various nodes and organization of nodes into layers. For example, nodes of a first layer (e.g., an input layer) may receive data as input data or application data. Such data can include, for example, one or more pixels per node (e.g., when the trained model is used for analysis, e.g., of an initial image). Subsequent intermediate layers may receive as input, output of nodes of a previous layer per the connectivity specified in the model form or structure. These layers may also be referred to as hidden layers. For example, a first layer may output a segmentation between a foreground and a background. A final layer (e.g., output layer) produces an output of the machine-learning model. For example, the output layer may receive the segmentation of the initial image into a foreground and a background and output whether a pixel is part of a mask or not. In some embodiments, the model form or structure also specifies a number and/or type of nodes in each layer.

In different embodiments, the trained model can include one or more models. One or more of the models may include a plurality of nodes, arranged into layers per the model structure or form. In some embodiments, the nodes may be computational nodes with no memory (e.g., configured to process one unit of input to produce one unit of output). Computation performed by a node may include, for example, multiplying each of a plurality of node inputs by a weight, obtaining a weighted sum, and adjusting the weighted sum with a bias or intercept value to produce the node output. In some embodiments, the computation performed by a node may also include applying a step/activation function to the adjusted weighted sum. In some embodiments, the step/activation function may be a nonlinear function. In various embodiments, such computation may include operations such as matrix multiplication. In some embodiments, computations by the plurality of nodes may be performed in parallel, e.g., using multiple processors cores of a multicore processor, using individual processing units of a graphics processing unit (GPU), or special-purpose neural circuitry. In some embodiments, nodes may include memory (e.g., may be able to store and use one or more earlier inputs in processing a subsequent input). For example, nodes with memory may include long short-term memory (LSTM) nodes. LSTM nodes may use the memory to maintain “state” that permits the node to act like a finite state machine (FSM).

In some embodiments, the trained model may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained (e.g., using training data) to produce a result.

Training may include applying supervised learning techniques. In supervised learning, the training data can include a plurality of inputs (e.g., initial images, user input, etc.) and a corresponding ground truth output for each input (e.g., a ground truth user-selected mask that correctly identifies pixels corresponding to a selected object, a ground truth segmentation mask that correctly identifies pixels corresponding to objects or regions, or a ground truth preserving mask that correctly identifies a portion of the subject, such as the subject's face, in each image). Based on a comparison of the output of the model with the ground truth output, values of the weights are automatically adjusted (e.g., in a manner that increases a probability that the model produces the ground truth output for the image).

In various embodiments, a trained model includes a set of weights, or embeddings, corresponding to the model structure. In some embodiments, the trained model may include a set of weights that are fixed, e.g., downloaded from a server that provides the weights. In various embodiments, a trained model includes a set of weights, or embeddings, corresponding to the model structure. In embodiments where data is omitted, the segmenter 204 may generate a trained model that is based on prior training (e.g., by a developer of the segmenter 204, by a third-party, etc.).

In some embodiments, the trained machine-learning model receives an initial image with one or more selected objects. In some embodiments, the trained machine-learning model outputs one or more user-selected masks that identify object pixels associated with the one or more objects in the initial image. In some embodiments, the trained machine-learning model receives an initial image and outputs one or more segmentation masks. In some embodiments, if the initial image includes one or more human subjects, the trained machine-learning model generates one or more preservation masks that correspond to the one or more human subjects. For example, the one or more preservation masks may be for faces of the one or more subjects.

The prompt engine 206 receives an initial image and an original prompt from the user interface module 202. In some embodiments, the prompt engine 206 also receives user input from the user interface module 202, such as selection of one or more objects and/or a region.

The prompt engine 206 (e.g., implemented with an LLM or another text generation model as a backend) generates a rewritten prompt based on the initial image, the original prompt, and user input if applicable. The rewritten prompt is designed to make the request from the user for an output image compatible with machine learning image generation models (e.g., include generation context, ensure that the prompt is within model limitations, include restrictions on generation, etc.). In some embodiments, the prompt engine 206 adds the name of the selected object and/or region to the rewritten prompt. For example, the prompt engine 206 receives an initial image of an eagle and an original prompt that states: “Reimagine to a cartoon look” and outputs a rewritten prompt that states: “Reimage to a cartoon eagle.”

In some embodiments, the description of the selected object may be specific. For example, the prompt engine 206 receives an original prompt that states: “ice” along with an initial image of a seal in water and outputs a rewritten prompt that states: “replace the background to water surface covered in broken ice.” In some embodiments, the rewritten prompt may include commands for multiple images. For example, the prompt engine 206 receives an original prompt of a man on a bicycle that is on a high sloped road that states “cliff and ominous clouds.” The prompt engine 206 rewrites the prompt to “replace the background to the cliff of a mountain with a very sharp drop under a sky with ominous clouds.”

In some embodiments, the prompt engine 206 implements a machine-learning model, such as a LLM (e.g., text generation LLM, multimodal LLM, etc.) that uses natural language processing (NLP) to provide conversational responses to text queries. In some embodiments, the LLM is stored on the computing device 220 or is stored on a separate server, such as the LLM 120 in FIG. 1.

In some embodiments, the machine-learning model includes an encoder that generates a representation of the original prompt, the initial image, and the user input. For example, the encoder receives an initial image of the Golden Gate Bridge and an original prompt that states “Reimagine to icy” with user input that selects the water region in the initial image.

The machine-learning model also includes a transformer for generating embeddings of the original prompt, the initial image, and the user input a self-attention mechanism for aggregating information from the embeddings to generate a rewritten prompt. Continuing with the example above, the transformer outputs a rewritten prompt that states: “Reimagine to icy water beneath a bridge on a cold winter day.”

In some embodiments, the prompt engine 206 includes a multilingual LLM that is capable of receiving input in languages other than English and outputs rewritten prompts in the language of an original prompt or a language that is compatible with the image generation machine-learning model.

The prompt engine 206 selects, based on the original prompt and/or the rewritten prompt, a machine-learning model from a set of machine-learning models to generate an output image. In some embodiments, the prompt engine 206 includes a base LLM that is used to select the machine-learning model. In some embodiments, the prompt engine 206 uses the LLM that also generates the rewritten prompt.

In some embodiments, the rewritten prompt includes a command of which machine-learning model to use from the set of machine-learning models. In some embodiments, the set of machine-learning models includes three types of machine-learning models: a structure-preserving machine-learning model, a shape preserving machine-learning model, and a non-structure and non-shape preserving machine-learning model. In various embodiments, two, three, four, or any other number of machine-learning models may be utilized. Different image generation machine-learning models may be implemented using different techniques (e.g., diffusion model, models trained using generative adversarial network methodology, or other types of models). In different embodiments, the different models may have different reliability, different image generation capabilities, different computational costs, etc. and selection of the model may be based on one or more of these model attributes.

In some embodiments, the prompt engine 206 selects the structure-preserving machine-learning model for rewritten prompts that request a modification to one or more objects or region in the initial image while preserving a structure and a shape of the one or more objects or the region. FIG. 5C includes an example of a rewritten prompt that requests a modification to a dog to change the dog's color from white to pink.

A structure-preserving machine-learning model is used for changing the color of an object because the structure-preserving machine-learning model is trained to keep the structure of the object that is modified for the output image. The structure-preserving machine-learning model uses depth control as a parameter during image generation. In some embodiments, a structure-preserving machine-learning model is trained to learn a joint embedding space where feature vectors for input text are closely associated with feature vectors for initial images and images with similar meaning are close to each other in the learned latent space.

A structure-preserving machine-learning model does not satisfy a rewritten prompt if the rewritten prompt requests a modification to one or more objects or a region of the initial image that changes the structure of the one or more objects or the region. For example, if the prompt requests an image of a lizard found in nature to be changed to a cartoon lizard, although the shape of the lizard remains the same, details such as the texture of the lizard are changed.

For rewritten prompts that request a modification to the one or more objects or the region in the initial image while preserving a shape of the one or more objects or the region, the prompt engine 206 selects the shape-preserving machine-learning model. In some embodiments, the shape-preserving machine-learning model makes modifications to a structure of the one or more objects or the region while preserving the shape and not using depth control.

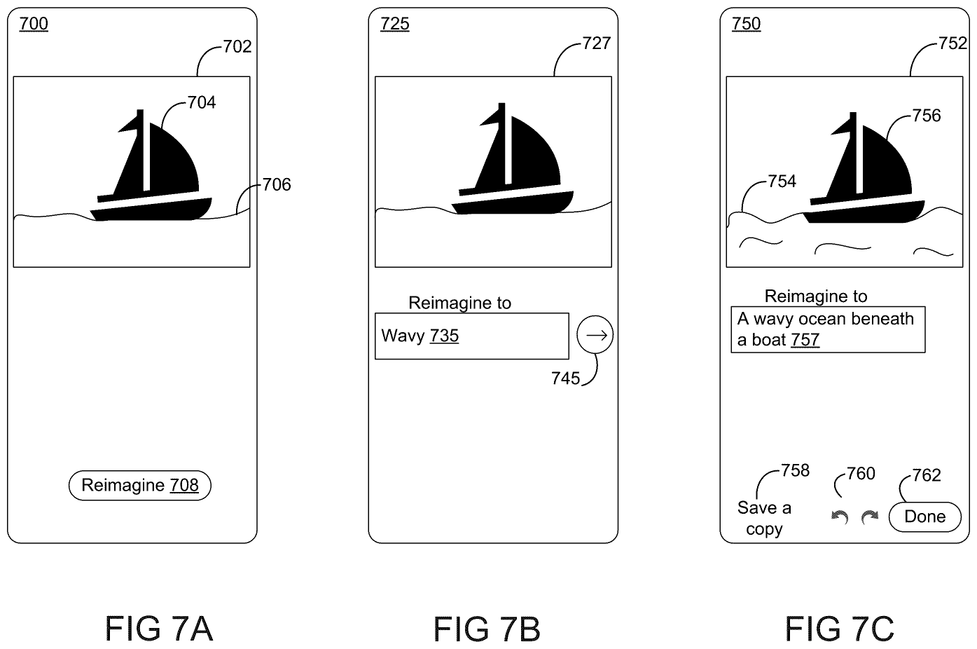

Turning to FIG. 7A, an example user interface 700 is illustrated that includes an initial image 702, according to some embodiments described herein. The initial image 702 includes a sailboat 704 and calm water 706. A user selects the reimagine button 708 to initiate a process for using a machine-learning model to modify the initial image 702.

FIG. 7B illustrates a user interface 725 that includes the initial image 727 and a text field 735 where the user has input “Wavy.” The prompt engine 206 generates a rewritten prompt from the original prompt that associates wavy with the water and not the sailboat because wavy is an attribute that is commonly associated with water and is not commonly associated with sailboats. The user selects the arrow button 745 to generate the output image.

In various embodiments, an LLM may perform a reasoning task to generate the rewritten prompt. For example, the LLM may be provided with a query “The user has provided a prompt that states wavy. The prompt is in the context of an image modification request. The initial image is a sailboat in calm water in an ocean. There are no other objects in the image. Please rewrite the user prompt based on this information.” In response, the LLM may perform reasoning (e.g., determine that the state “wavy” is frequently associated with water including oceans or lakes that may be traveled on by sailboats and not with sailboats), and thereby, determine that the rewritten prompt is to indicate that the ocean is to be wavy in the output image. In comparison, if the user input text states “sails full,” the LLM may reason that the text corresponds to the sails of the sailboat being fully inflated (e.g., due to the presence of strong winds) and rewrite the prompt as “a sailboat in the ocean having its sails full.” In another example, if the user input text states “topsy-turvy ride,” the LLM may rewrite the prompt as “a sailboat in strong ocean waves, the boat not level with the ocean surface.” The LLM may perform such reasoning tasks based on mapping the user input text (with the additional context) in latent space to generate output text that is responsive to the reasoning task included in the input to the LLM.

FIG. 7C illustrates a user interface 750 that includes an output image 752 that satisfies a rewritten prompt, according to some embodiments described herein. In this example, the rewritten prompt is illustrated in the text field 757 as “A wavy ocean beneath a boat” as being visible to users, but in some embodiments the rewritten prompt is used as part of the image generation process and is not shown to users.

The output image 752 is responsive the rewritten prompt as it includes a wavy ocean 754 beneath a boat 756. If a user is satisfied with the output image 752, the user may select the “save a copy” link 758. If the user wants to undo or redo the generation, the user may select the arrows 760. The user may also select the “done” button 762 to complete the editing of the output image 752.

The prompt engine 206 selected the shape-preserving machine-learning model to generate the output image in this example because the shape of the water remained the same while the structure of the water from calm to way changed. The shape-preserving machine-learning model did not use depth control as a parameter because changing the structure of the region also results in changes to the depth of the region.

A structure-preserving machine-learning model and a shape-preserving machine-learning model do not satisfy a rewritten prompt if the rewritten prompt requests a replacement of the one or more objects or the region of the initial image because the shape and the structure of the one or more objects or the region in the initial image may be modified. For example, if a user requests to replace a glass with a mug, the glass and the mug have different shapes and structures. If a structure-preserving machine-learning model or a shape-preserving machine-learning model is used to generate the output image, the output image may include two mugs that are stacked to resemble the shape of the glass. Conversely, if a non-structure and non-shape preserving machine-learning model is used to generate the output image, the output image includes a mug with a mug shape and structure that is not constrained by the attributes of the glass in the image.

In some embodiments, the prompt engine 206 selects a non-structure and non-shape preserving machine-learning model when the rewritten prompt requests a replacement of the one or more objects or the region in the initial image with one or more new objects or a new region. In some embodiments, prompt engine 206 selects a non-structure and non-shape preserving machine-learning model when the rewritten prompt requests an additional object to be added to the initial image.

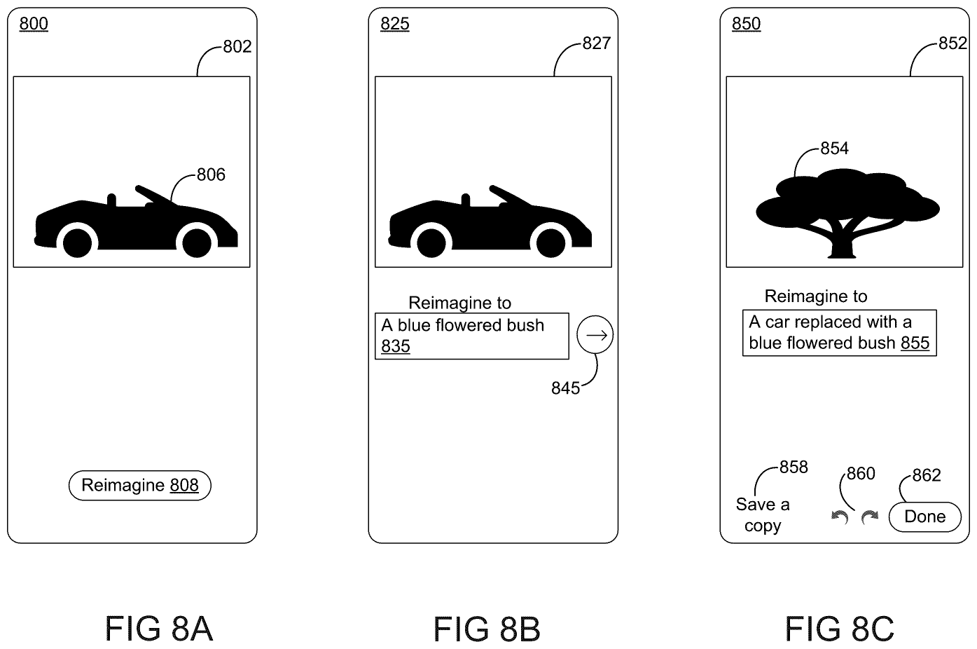

FIG. 8A illustrates an example user interface 800 that includes an initial image 802 of a car 806, according to some embodiments described herein. A user may select the reimagine button 808 to initiate a process for using a machine-learning model to generate an output image.

FIG. 8B illustrates an example user interface 825 that includes an initial image 827 and a text field 835 where a user has provided the following original prompt: “A blue flowered bush.” The user selects the arrow button 845 to generate the output image.

A prompt engine 206 generates a rewritten prompt with the following: “A car replaced with a blue flowered bush.” FIG. 8C illustrates an example user interface 850 that includes an output image 852 with the blue flowered bush 854 and the rewritten prompt in the text field 855. In some embodiments, the rewritten prompt is not provided for users to view. The user may save a copy of the output image by selecting the “Save a copy” link 858, undo the changes by selecting the undo button 860, or select the done button 862.

In some embodiments, the user interface includes a request for confirmation from a user that the output image satisfied the original prompt. For example, the original prompt may be “Change the sky to cloudy.” The user interface module 202 may provide the output image with an option to regenerate the output image using a regenerate button, a text field (such as the text field 855 in FIG. 8C), and/or the statement “I changed the sky, is it OK?” The user may provide a subsequent prompt, such as “No, I meant feather clouds.” The prompt engine 206 may generate a subsequent rewritten prompt based on the subsequent prompt. The selected machine-learning model generates a subsequent output image based on the subsequent prompt or the rewritten prompt and the user interface module 202 provides the subsequent output image to the user. The user may continue to modify the subsequent output image until the user is satisfied.

In some embodiments, the prompt engine 206 generates rewritten prompts for presets. For example, if a user selects a preset that states “fence removal,” the prompt engine 206 may generate a rewritten prompt that is particular to the initial image. For example, if the user selects the fence removal prompt 308 in FIG. 7A, the prompt engine 206 may generate a rewritten prompt that states “remove a fence from the image so that the baseball player is visible using the non-structure and non-shape preserving machine-learning model.”

The machine-learning module 208 trains machine-learning models to generate output images based on rewritten prompts and initial images. In some embodiments, the machine-learning module 208 receives a command from the prompt engine 206 to generate the output image based on a machine-learning model selected by the prompt engine 206 along with the initial image, the rewritten prompt, and user input if available. In some embodiments, the machine-learning model is selected from a structure-preserving machine-learning model, a shape-preserving machine-learning model, or a non-structure and non-shape preserving machine-learning model.

The machine-learning module 208 trains and implements a machine-learning model to receive an initial image and a textual request to generate an output image; the segmentation mask or a user-selected mask as input and/or the preserving mask.

A diffusion model generates an output image that satisfies the textual request and that does not include object pixels that are associated with a human subject. In some embodiments, the diffusion model receives an empty mask as input that identifies all the pixels in the initial image as being not associated with a human (regardless of whether the initial image includes a human). As a result of using the empty mask, the machine-learning module 208 generates an output image that does not include human pixels.

In some embodiments where the initial image includes a human subject (either as a selected object or present in the image), the machine-learning model also receives the preserving mask from the segmenter 204. The preserving mask is used to prevent modification by the machine-learning model to the human subject during the generation of the output image.

In some embodiments, the machine-learning model is a diffusion model, and the machine-learning module 208 trains the diffusion model with a two-step process to generate an output image. First, the diffusion model is trained to perform a forward diffusion process on an initial image where Gaussian noise with variance is added to obtain a noisy image. The Gaussian noise with variance is added to obtain progressively noisier images until the final noisy image is achieved. Second, the diffusion model is trained to perform a reverse diffusion process that uses a convolutional neural network (CNN) to transform the final noisy image into meaningful output (e.g., output image).

The machine-learning module 208 trains the diffusion model to perform forward diffusion by using training data that includes initial images. The machine-learning module 208 converts the initial images to tensors. A tensor is an array of bytes with any number of dimensions. The tensor may be described as having an arbitrary shape since the tensor may have any number of dimensions. The machine-learning module 208 parses the bytes in the tensors to convert them into pixel data for the red green blue (RGB) color channels.

The machine-learning module 208 may sample noise to match the shape (dimensions) of the initial images. The machine-learning module 208 may sample random diffusion times and use these to generate the noise and signal rates according to a diffusion schedule. The machine-learning module 208 applies weightings to the initial images to generate the noisy images. In some embodiments where the diffusion model is used to generate an output image from text, each forward diffusion step predicts the noise from a noisy image and text embedding generated from the text.

The machine-learning module 208 calculates the loss (e.g., a mean absolute error) between the predicted noise and noise from a ground truth image and takes a gradient step against this loss function. After the gradient step, the neural network weights of the diffusion model (under training) are updated to a weighted average of the existing weights and the trained neural network weights.

The machine-learning module 208 may train the diffusion model to perform reverse diffusion and denoise a noisy image so that it satisfies a textual request by instructing the neural network to predict the noise and then undo the noising operation using noise rates and signal rates. The diffusion model includes a CNN, which includes convolutional layers where the output of one layer serves as input to a subsequent layer. The convolutional layers include downsampling blocks, where the initial images are compressed spatially but expanded channel wise, and upsampling blocks where representations are expended spatially while the number of channels is reduced.

The machine-learning module 208 provides a noise variance and the noisy image as described by tensors as input to a first convolutional layer in the CNN to increase the number of channels. The noise variance and the noisy image are concatenated across channels. In some embodiments, the machine-learning module 208 includes skip connections between output from convolutional layers that perform downsampling and convolutional layers that perform upsampling for equivalent spatially shaped layers in the network. A final convolutional layer may reduce the number of channels to the three RGB channels.

During training for the reverse diffusion process, the machine-learning module 208 predicts noise in order to remove the noise from the noisy image to achieve the initial image. The machine-learning module 208 performs the prediction over a number of steps and the number of steps may be different from the number of steps used during training for the forward diffusion process.

### Structure Preserving Machine-Learning Model

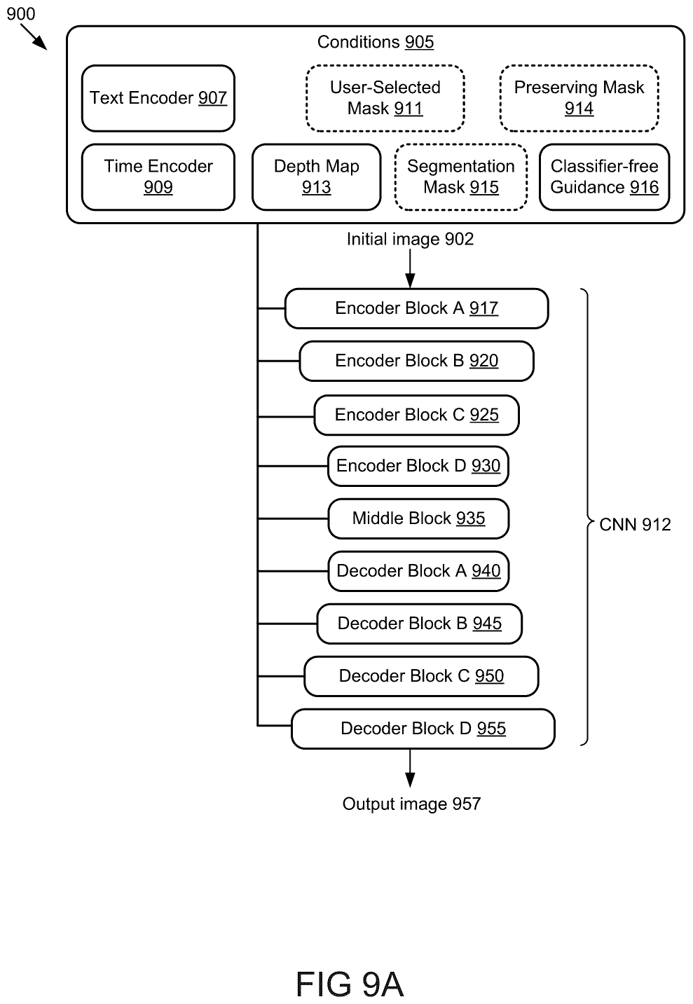

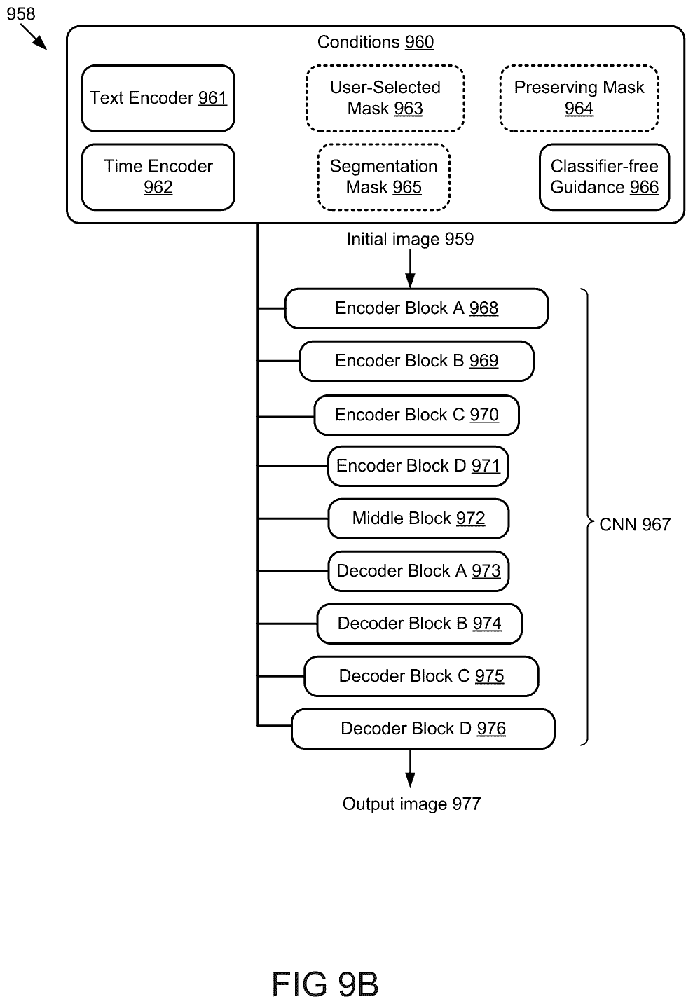

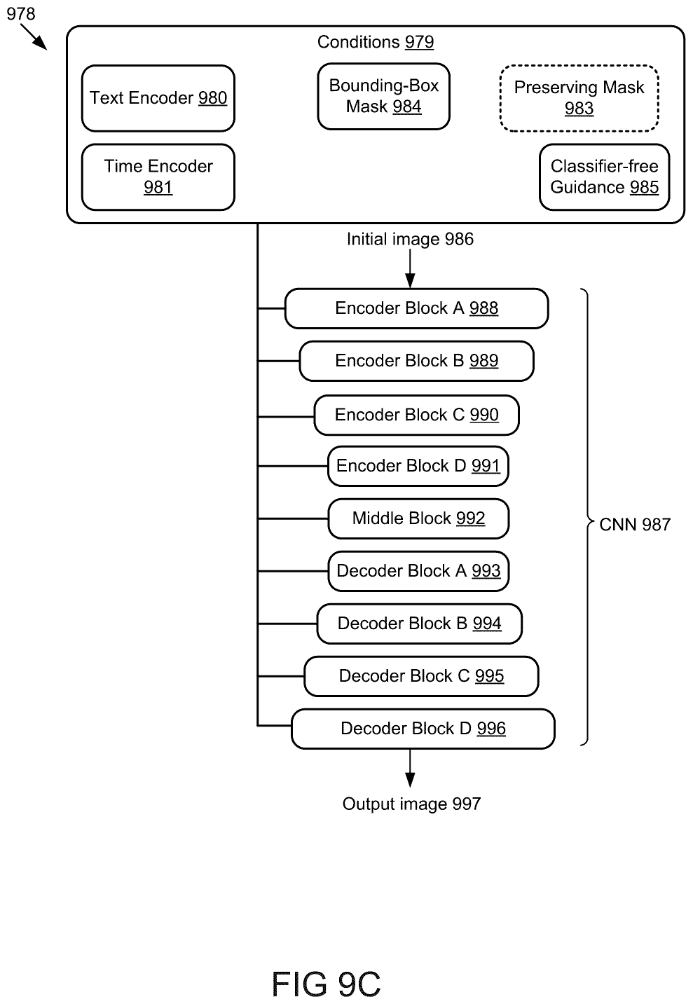

FIG. 9A illustrates an architecture of an example structure preserving machine-learning model, according to some embodiments described herein. In some embodiments, the structure preserving machine-learning model is a diffusion model 900. The diffusion model 900 may be a part of the media application 103 of FIG. 1 and/or the machine-learning model 208 of FIG. 2.

The diffusion model 900 is trained using training data that includes initial images 902 and conditions 905. In some embodiments, the training data includes ground truth output images, such as output images that satisfy textual requests and that have modifications to one or more objects or a region that include a same structure and a same shape. For example, the initial image may include an object with a first color (e.g., a green trampoline) and the ground truth image includes the object with a second color (e.g., a purple trampoline). In some embodiments, training data further includes pairs of ground truth images and corresponding images with randomly masked portions of the ground truth images.

The conditions 905 include a text encoder 907, a time encoder 909, an optional user-selected mask 911, a depth map 913, an optional preserving mask 914, an optional segmentation mask 915, and classifier-free guidance 916. The text encoder 907 encodes a textual request (i.e., a textual condition) by converting the text to tokens for a vector that represents the textual request in vector space (embedding space). The time encoder 909 encodes diffusion timestamps using positional encoding.

The user-selected mask 911 identifies object pixels associated with one or more objects or a region that are selected by a user in the initial image. During inference (i.e., during generation of an output image), the user-selected mask 911 identifies the area to be modified in the output image. The user-selected mask 911 may identify object pixels that are associated with one or more selected objects.

The depth map 913 identifies a depth of one or more of the image pixels in the initial image. The depth map 913 is provided as input to the CNN 912 to preserve the relative depth of various objects in the initial image in the output image. For example, if a selected image includes a door with a handle, the depth map 913 is used to preserve the structure of the door and maintain the handle in the output image. The depth map 913 is used for requests where a user wants the output image to maintain photorealism.

The preserving mask 914 identifies pixels that correspond to human subjects in the initial image and that are to be preserved during generation of the output image 957. For example, the preserving mask may include a human subject's hair if the user indicates that the hair is to remain the same (or more generally, does not specify changes to the hair in conditions 905), the human subject's fingers, a subject's entire body where the subject is a pet to prevent the pet from being overly modified, etc. In some embodiments where the output image modifies the clothing of the human subject, the preserving mask excludes pixels of the clothing of the human subject and instead includes the remaining pixels associated with the human subject to prevent modification to the human subject by the diffusion model 900. In some embodiments, multiple different generative machine learning diffusion models may be trained and available for use in image generation (e.g., shape-preserving model, structure-preserving model, etc.). In some embodiments, instead of using a preserving mask 914, the conditions 905 may include an empty mask that identifies all pixels in the initial image 902 as not being associated with a human.

The segmentation mask 915 identifies the one or more objects or one or more regions in the initial image 902. In some embodiments, the segmentation mask 915 is used if the user-selected mask 911 is not used. In some embodiments, the segmentation mask 915 is used in addition to using the user-selected mask 911 to improve identification of the user-selected mask 911.

In some embodiments, the depth in the output image is controlled with classifier-free guidance 916. Classifier guidance controls the categories generated by a classification model. Classifier-free guidance 916 trains the diffusion model 900 on conditions with conditioning dropout, which is when some percentage of the time, the conditions are removed. In some embodiments, removed conditions are replaced with a special input value that represents an absence of conditioning information. A higher conditioning dropout value preserves a structure of the one or more objects in the initial image more than a lower conditioning dropout value. One disadvantage of the higher conditioning dropout value is that the increased structure may come at a cost of decreased diversity of output images.

The initial image(s) 902 are provided as input to a first layer of a CNN 912 and the conditions 905 are provided as input to each block within the CNN 912. The CNN 912 includes encoder blocks 917, 920, 925, 930; a middle block 935; and skip-connected decoder blocks 940, 945, 950, 955. In some embodiments, the model is a diffusion model 900 and contains 25 blocks where 8 blocks are down-sampling or up-sampling convolutional layers. While FIG. 9A shows four encoder blocks and four decoder blocks, in various embodiments, fewer or greater numbers of encoder blocks and/or decoder blocks can be used (and the number of encoder blocks and the number of decoder blocks may be different).

The denoising process may occur in pixel space or in latent space of the diffusion model 900. In some embodiments, during training, the machine-learning module 208 performs preprocessing on initial images 902 to convert the initial images 902 from pixel-space images to latent space (e.g., a vector representation of the image in high-dimensional vector space). The machine-learning module 208 performs training by converting one or more of the conditions 905 from an input size to a feature space vector that matches the size of the CNN 912.

The machine-learning module 208 trains the diffusion model 900 to receive an initial image 902 and progressively add noise to the initial image 902 with each iteration of the diffusion model 900 to produce a noisy image. Given a set of conditions 905 including time generated by the time encoder 909, textual requests encoded by the text encoder 907, and other task-specific conditions (e.g., the user-selected mask 911, the depth map 913, the preserving mask 914, the segmentation mask 915, and classifier-free guidance 916), image diffusion models are trained to predict the noise added to the noisy image. The machine-learning module 208 trains the diffusion model 900 to generate a plurality of output images (via a denoising process) that satisfy the textual requests and that do not include human pixels by progressively removing the noise. In some embodiments, the denoising during training includes about 10,000 optimization steps to minimize loss between generated output images and ground truth output images.

In some embodiments, the machine-learning module 208 trains the diffusion model using three different versions of varying amounts of textual requests and depth values. For example, the machine-learning module 208 may run a first version of the diffusion model with no textual requests and no depth values, run a second version of the diffusion model with the textual requests and no depth values, and run a third version of the diffusion model with the textual requests and the depth values. Training each version of the diffusion model may include multiple iterations.

Once the diffusion model is trained, the trained diffusion model receives the textual request to generate the output image, a corresponding depth map, and the user-selected mask and/or the segmentation mask, wherein the diffusion model is trained to generate output pixels that are not associated with the human subject. The diffusion model performs a diffusion process on the initial image to generate a noisy image based on the initial image. In some embodiments, the diffusion model performs an inverse diffusion process, such as a DDIM inversion, to generate an output image from the noisy image, where the output image is generated in accordance with conditions 905. The diffusion model performs reverse diffusion by predicting noise added to the noisy image and generating an output image that satisfies the textual request.

### Shape Preserving Machine-Learning Model

FIG. 9B illustrates an architecture of an example shape preserving machine-learning model, according to some embodiments described herein. In some embodiments, the shape preserving machine-learning model is a diffusion model 958. The diffusion model 958 may be a part of the media application 103 of FIG. 1 and/or the machine-learning model 208 of FIG. 2.

The diffusion model 958 is trained using training data that includes initial images 959 and conditions 960. In some embodiments, the training data includes ground truth output images, such as output images that satisfy textual requests and that have modifications to one or more objects or a region that include a same shape. For example, the initial image may include an object with a first texture (e.g., a realistic cat) and the ground truth includes the object with a second texture (e.g., a cartoon version of the cat). In some embodiments, training data further includes pairs of ground truth images and corresponding images with randomly masked portions of the ground truth images.

In some embodiments, the architecture for the diffusion model 958 is similar to the structure preserving machine-learning model, except that the shape preserving machine-learning model does not include a depth map as input. The conditions 960 include a text encoder 961, a time encoder 962, an optional user-selected mask 963, an optional preserving mask 964, an optional segmentation mask 965, and classifier-free guidance 966. Because these conditions 960 are similar to the conditions 905 described with reference to FIG. 9A, further details will not be repeated here.

The initial image(s) 959 are provided as input to a first layer of a CNN 967 and the conditions 960 are provided as input to each block within the CNN 967. The CNN 967 includes encoder blocks 968, 969, 970, 971; a middle block 972; and skip-connected decoder blocks 973, 974, 975, 976. Because the CNN 967 is similar to the CNN 912 described with reference to FIG. 9A, further details will not be repeated here. The diffusion model 958 is trained to generate an output image 977 that satisfies the rewritten prompt.

### Non-Structure and Non-Shape Preserving Machine-Learning Model

FIG. 9C illustrates an architecture of an example non-structure and non-shape preserving machine-learning model, according to some embodiments described herein. In some embodiments, the non-structure and non-shape preserving machine-learning model is a diffusion model 978. The diffusion model 978 may be a part of the media application 103 of FIG. 1 and/or the machine-learning model 208 of FIG. 2.

The diffusion model 978 is trained using training data that includes initial images 986 and conditions 979. In some embodiments, the training data includes ground truth output images, such as output images that satisfy textual requests and that have modifications to one or more objects or a region that do not include a same structure or a same shape. For example, the initial image may include a first object (e.g., a dog) and the ground truth image includes the object with a second object (e.g., a cat). In some embodiments, the training data further includes an initial image and the ground truth image includes an object that was not present in the initial image. In some embodiments, training data further includes pairs of ground truth images and corresponding images with randomly masked portions of the ground truth images.

In some embodiments, the architecture for the diffusion model 978 is similar to the structure preserving machine-learning model, except that the non-structure and non-shape preserving machine-learning model does not include a depth map, a user-selected mask, or a segmentation mask as conditions 979. In addition, for examples where a first object is being replaced with a second object, the conditions include a bounding-box mask 984 that indicates a location where the second object is to be located. The conditions 979 additionally include a text encoder 980, a time encoder 981, an optional preserving mask 983, and classifier-free guidance 985. Because these conditions 979 are similar to the conditions 905 described with reference to FIG. 9A, further details will not be repeated here.

The initial image(s) 986 are provided as input to a first layer of a CNN 987 and the conditions 979 are provided as input to each block within the CNN 987. The CNN 987 includes encoder blocks 988, 989, 990, 991; a middle block 992; and skip-connected decoder blocks 993, 994, 995, 996. Because the CNN 987 is similar to the CNN 912 described with reference to FIG. 9A, further details will not be repeated here. The diffusion model 958 is trained to generate an output image 997 that satisfies the rewritten prompt.

### Method

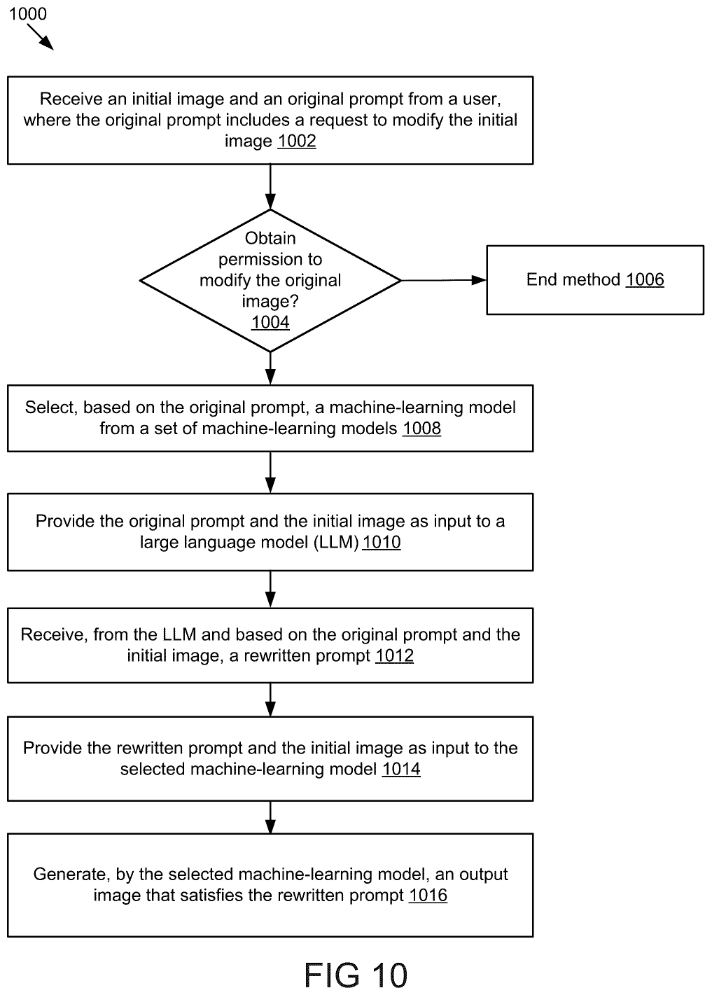

FIG. 10 illustrates an example method 1000 to generate an output image based on a rewritten prompt. The method 1000 may be performed by the computing device 200 in FIG. 2. In some embodiments, the method 1000 is performed by the user device 115, the media server 101, or in part on the user device 115 and in part on the media server 101 in FIG. 1.

The method 1000 of FIG. 10 may begin at block 1002. At block 1002, an initial image and an original prompt are received from a user. In some embodiments, only an original prompt may be received (e.g., to generate fresh images responsive to the original prompt). In some embodiments, the initial image and the original prompt may be received, for example, to generate modified images that preserve some aspects (e.g., shape, structure, color palette, objects, etc.) from the initial image in the modified images, while also generating the modified images to be responsive to the original prompt. Block 1002 may be followed by block 1004.

At block 1004, it is determined whether permission is obtained to modify the original image. For example, a user is presented with a request to provide permission. If permission is not obtained, block 1004 may be followed by block 1006 where the method 1000 ends. If permission is obtained, block 1004 may be followed by block 1008.

At block 1008, a machine-learning model is selected from a set of machine-learning models based on the original prompt. In some embodiments, the machine-learning model is selected from a base LLM that is part of the computing device 200 or an LLM that is not part of the computing device 200, such as the LLM 120 illustrated in FIG. 1. In some embodiments where the machine-learning model is selected from the LLM 120, the selection is further based on the rewritten prompt. For example, the LLM 120 may generate a rewritten prompt that includes a command to use the selected machine-learning model.

In some embodiments, model selection may be performed by the LLM or by a separate model selection module (e.g., a prompt engine, a different machine-learning model, a classifier, or other selection algorithm). In embodiments where an LLM or other machine-learning model is utilized for model selection, the rewritten prompt, along with information regarding attributes of the available generative models may be provided to the LLM as an input along with a command that indicates that the LLM output is to indicate a particular model of the available generative models to be utilized for image generation based on the rewritten prompt. In some embodiments, the set of machine-learning models includes a structure-preserving machine-learning model, a shape-preserving machine-learning model, and a non-structure and non-shape preserving machine-learning model, such as depicted in FIGS. 9A-9C and previously described above.

The structure-preserving machine-learning model may be selected based on the rewritten prompt including a command to modify the one or more objects or the region in the initial image while preserving a structure of the one or more objects or the region. Providing the rewritten prompt and the initial image as input to the structure-preserving machine-learning model may further include providing the rewritten prompt, the initial image, and a depth map of the initial image to the structure-preserving machine-learning model.

The shape-preserving machine-learning model may be selected based on the rewritten prompt including a command to modify the one or more objects or the region in the initial image while preserving a shape of the one or more objects or the region.

The non-structure and non-shape preserving machine-learning model may be based on the rewritten prompt including a command to replace the one or more objects or the region in the initial image with one or more new objects or a new region. In some embodiments, the method 1000 further includes generating a minimum bounding box that surrounds one or more selected objects in the initial image, responsive to selecting the non-structure and non-shape preserving machine-learning model, generating a bounding-box mask based on the minimum bounding box, and providing, along with the rewritten prompt and the initial image, the bounding-box mask as input to the non-structure and non-shape preserving machine-learning model. The non-structure and non-shape preserving machine-learning model may be based on the rewritten prompt including a command to generate an additional object to be added to the initial image. Block 1008 may be followed by block 1010.

At block 1010, the original prompt and the initial image are provided as input to an LLM (e.g., the LLM 120 of FIG. 1 or an LLM that is part of the prompt engine 206 in FIG. 2 or another text generation model). In some embodiments, the LLM also receives user input that identifies one or more objects or a region in the initial image. Block 1010 may be followed by block 1012.

At block 1012, a rewritten prompt is received from the LLM based on the original prompt and the initial image. In some embodiments, the rewritten prompt is also based on identification of the one or more objects or the region in the initial image that is to be modified. In various embodiments, prompt rewriting by an LLM (or other text generation model) can ensure that the input to the generative model is crafted such that the model output specifically includes images that meet the criteria, e.g., greater or lower level of realism, artistic effects as specified in the prompt, ensure that the output image is compliant with applicable regulations and safe for viewing, etc. In some embodiments, the rewritten prompt may include the initial image provided by the user or a representation of the initial image (e.g., an embedding of the initial image). Block 1012 may be followed by block 1014.

At block 1014, the rewritten prompt and the initial image (or an embedding representing the initial image) are provided as input to the selected machine-learning model. Block 1014 may be followed by block 1016.

At block 1016, the machine-learning model outputs an output image that satisfies the rewritten prompt.

In some embodiments, the method 1000 further includes generating a user interface that includes the initial image and an option to apply a preset to modify the initial image and responsive to receiving selection of the preset, outputting, by the machine-learning model, the output image that satisfies a command associated with the preset. In some embodiments, the preset includes at least one option selected from a group of removing a fence from the initial image, erasing an object in the initial image, adding a new object to the initial image, changing a material or color of an object in the initial image, enhancing the initial image, replacing a background of the initial image, changing a subject in the initial image (e.g., changing an expression of the subject, changing a feature of the subject, changing clothing of the subject, etc.), and combinations thereof. In some embodiments, the method 1000 further includes providing the output image with an option to regenerate the output image, receiving a subsequent prompt from the user, and generating a subsequent output image based on the subsequent prompt.

In various embodiments, the original prompt from the user and/or the rewritten prompt from the LLM may be subject to one or more filters to ensure that the generated output image is compliant with applicable rules and standards. For example, the filters may detect textual requests that prevent certain modifications to the image (e.g., addition of a prohibited category of object, changes to objects in the image that meet certain criteria, etc.). In response to such detection, the user is provided with guidance regarding the types of textual requests that are impermissible. Additionally, the user may be provided guidance regarding structuring the textual request to specify their requirement with respect to the output image.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Some portions of the detailed descriptions above are presented in terms of algorithms and symbolic representations of operations on data bits within a computer memory. These algorithmic descriptions and representations are used by those of ordinary skill in the data processing arts to most effectively convey the substance of their work to others. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
receiving an initial image and an original prompt from a user, wherein the original prompt includes a request to modify the initial image;
selecting, based on the original prompt, a machine-learning model from a set of machine-learning models;
providing the original prompt and the initial image as input to a large language model (LLM);
receiving, from the LLM and based on the original prompt and the initial image, a rewritten prompt;
providing the rewritten prompt and the initial image as input to the selected machine-learning model; and
generating, by the selected machine-learning model, an output image that satisfies the rewritten prompt.

2. The method of claim 1, further comprising receiving user input that identifies one or more objects or a region in the initial image, wherein the rewritten prompt is further based on identification of the one or more objects or the region in the initial image that is to be modified.

3. The method of claim 2, wherein the set of machine-learning models includes a structure-preserving machine-learning model, a shape-preserving machine-learning model, and a non-structure and non-shape preserving machine-learning model.

4. The method of claim 3, wherein selecting the machine-learning model includes selecting the structure-preserving machine-learning model based on the rewritten prompt including a command to modify the one or more objects or the region in the initial image while preserving a structure of the one or more objects or the region.

5. The method of claim 4, wherein providing the rewritten prompt and the initial image as input to the selected machine-learning model further includes providing the rewritten prompt, the initial image, and a depth map of the initial image to the structure-preserving machine-learning model.

6. The method of claim 3, wherein selecting the machine-learning model includes selecting the shape-preserving machine-learning model based on the rewritten prompt including a command to modify the one or more objects or the region in the initial image while preserving a shape of the one or more objects or the region.

7. The method of claim 3, wherein selecting the machine-learning model includes selecting the non-structure and non-shape preserving machine-learning model based on the rewritten prompt including a command to replace the one or more objects or the region in the initial image with one or more new objects or a new region.

8. The method of claim 7, further comprising:
generating a minimum bounding box that surrounds one or more selected objects in the initial image;
responsive to selecting the non-structure and non-shape preserving machine-learning model, generating a bounding-box mask based on the minimum bounding box; and
providing, along with the rewritten prompt and the initial image, the bounding-box mask as input to the non-structure and non-shape preserving machine-learning model.

9. The method of claim 3, wherein, selecting the machine-learning model includes selecting the non-structure and non-shape preserving machine-learning model based on the rewritten prompt including a command to generate an additional object to be added to the initial image.

10. The method of claim 1, further comprising:
generating a user interface that includes the initial image and an option to apply a preset to modify the initial image; and
responsive to receiving selection of the preset, outputting, by the machine-learning model, the output image that satisfies a command associated with the preset.

11. The method of claim 10, wherein the preset includes at least one option selected from a group of removing a fence from the initial image, erasing an object in the initial image, adding a new object to the initial image, changing a material or color of an object in the initial image, enhancing the initial image, replacing a background of the initial image, changing a subject in the initial image (e.g., changing an expression of the subject, changing a feature of the subject, changing clothing of the subject, etc.), and combinations thereof.

12. A non-transitory computer-readable medium with instructions stored thereon that, when executed by one or more computers, cause the one or more computers to perform or control performance of operations, the operations comprising:
receiving an initial image and an original prompt from a user, wherein the original prompt includes a request to modify the initial image;
selecting, based on the original prompt, a machine-learning model from a set of machine-learning models;
providing the original prompt and the initial image as input to a large language model (LLM);
receiving, from the LLM and based on the original prompt and the initial image, a rewritten prompt;
providing the rewritten prompt and the initial image as input to the selected machine-learning model; and
generating, by the selected machine-learning model, an output image that satisfies the rewritten prompt.

13. The non-transitory computer-readable medium of claim 12, wherein the operations further include receiving user input that identifies one or more objects or a region in the initial image, wherein the rewritten prompt is further based on identification of the one or more objects or the region in the initial image that is to be modified.

14. The non-transitory computer-readable medium of claim 13, wherein the set of machine-learning models includes a structure-preserving machine-learning model, a shape-preserving machine-learning model, and a non-structure and non-shape preserving machine-learning model.

15. The non-transitory computer-readable medium of claim 12, wherein the operations further include:
providing the output image with an option to regenerate the output image;
receiving a subsequent prompt from the user; and
generating a subsequent output image based on the subsequent prompt.

16. A system comprising:
one or more processors; and
one or more computer-readable media coupled to the one or more processors, having instructions stored thereon that, when executed by the one or more processors, cause the one or more processors to perform or control performance of operations comprising:
receiving an initial image and an original prompt from a user, wherein the original prompt includes a request to modify the initial image;
selecting, based on the original prompt, a machine-learning model from a set of machine-learning models;
providing the original prompt and the initial image as input to a large language model (LLM);
receiving, from the LLM and based on the original prompt and the initial image, a rewritten prompt;
providing the rewritten prompt and the initial image as input to the selected machine-learning model; and
generating, by the selected machine-learning model, an output image that satisfies the rewritten prompt.

17. The system of claim 16, wherein the operations further include receiving user input that identifies one or more objects or a region in the initial image, wherein the rewritten prompt is further based on identification of the one or more objects or the region in the initial image that is to be modified.

18. The system of claim 17, wherein the set of machine-learning models includes a structure-preserving machine-learning model, a shape-preserving machine-learning model, and a non-structure and non-shape preserving machine-learning model.

19. The system of claim 18, wherein selecting the machine-learning model includes selecting the structure-preserving machine-learning model based on the rewritten prompt including a command to modify the one or more objects or the region in the initial image while preserving a structure of the one or more objects or the region.

20. The system of claim 18, wherein selecting the machine-learning model includes selecting the shape-preserving machine-learning model based on the rewritten prompt including a command to modify the one or more objects or the region in the initial image while preserving a shape of the one or more objects or the region.
